(19) United States
(12) Patent Application Publication
(10) Pub. No.: US 2018/0090040 A1
(43) Pub. Date: Mar. 29, 2018

(54) UNMANNED AERIAL DISPLAY

(71) Applicants: Patrick Randall, Newbury Park, CA (US); Joeseph Bernstein, Agoura Hills, CA (US)

(72) Inventors: Patrick Randall, Newbury Park, CA (US); Joeseph Bernstein, Agoura Hills, CA (US)

(21) Appl. No.: 15/626,181

(22) Filed: Jun. 19, 2017

Related U.S. Application Data
(60) Provisional application No. 62/399,855, filed on Sep. 26, 2016.

(51) Int. Cl. G09F 21/08; B64C 39/02; B64C 27/20

(52) U.S. Cl. CPC G09F 21/08; B64C 39/024; B64C 27/20; B64C 2201/027; B64C 2201/162; B64C 2201/108; B64C 2201/12; B64C 2201/141; B64C 2201/146; B64C 2201/042

(57) ABSTRACT

An unmanned aerial vehicle for providing digital messaging and observer interaction. The present invention relates to an unmanned aerial vehicle with displays attached thereto. In particular, an unmanned aerial display which is capable of flying under its own propulsion and power is programmed and/or controlled to deliver various content, messaging and advertising.

### RELATED APPLICATIONS

This application claims priority to U.S. Provisional Patent Application No. 62/399,855 entitled, “Unmanned Aerial Display” filed on Sep. 26, 2016, which is hereby incorporated by reference in its entirety.

### TECHNICAL FIELD

The present invention relates generally to an aerial display assembly capable of flying under its own power. In particular, the present invention utilizes a frame having a plurality of displays disposed thereon propelled by a plurality of rotors and controlled by flight control computers.

### BACKGROUND

Given the rise in popularity of unmanned aerial vehicles particularly in commercial, new applications of the technology are being explored at an increasing rate. An unmanned aerial vehicle (UAV), commonly known as a drone, unmanned aircraft system (UAS), or by several other names, is an aircraft without a human pilot aboard. The flight of UAVs may operate with various degrees of autonomy: either under remote control by a human operator, or fully or intermittently autonomously, by onboard computers.

UAVs were originally developed primarily for military applications, as their use is often preferred for missions that are too “dull, dirty or dangerous” for humans. However, their application is expanding in commercial, scientific, recreational, agricultural, and other applications, such as, policing and surveillance, product deliveries, aerial photography, agriculture and drone racing. Civilian drones now vastly outnumber military drones, with estimates of over a million sold by 2015.

New and innovative adverting are continuously being developed. Out-of-home Media Advertising (also known as, OOH advertising or outdoor advertising) or out-of-home media (also known as, OOH media or outdoor media) is advertising that reaches the consumers while they are outside their homes. Out-of-home media advertising is focused on marketing to consumers when they are “on the go” in public places, in transit, waiting (such as in a medical office), and/or in specific commercial locations (such as in a retail venue). OOH advertising formats fall into four main categories: billboards, street, roads, highways, transit, and alternative.

Billboard advertising is a traditional OOH advertising format, but there has been significant growth in digital OOH (digital billboards and place-based networks) in recent years; for example, about 4,900 digital billboard displays have been installed in China and the United States. Traditional roadside billboards remain the predominant form of OOH advertising in the US with 66 percent of total annual revenue. Today, billboard revenue is 73 percent local ads, 18 percent national ads, and 9 percent public service ads.

Transit advertising is typically advertising placed on anything which moves, such as buses, subway advertising, truck-side, food trucks, and taxis, but also includes fixed static and electronic advertising at train and bus stations and platforms. Airport advertising, which helps businesses address an audience while traveling, is also included in this category. Municipalities often accept this form of advertising, as it provides revenue to city and port authorities.

Digital out-of-home (DOOH) refers to dynamic media distributed across placed-based networks in venues including, but not limited to: cafes, bars, restaurants, health clubs, colleges, arenas, gas stations, convenience stores, barber shops, and public spaces. PQ Media defines DOOH by two major platforms, digital place-based networks (DPN) and digital billboards & signage (DBB); DOOH networks typically feature independently addressable screens, kiosks, jukeboxes and/or jumbotrons. DOOH media benefits location owners and advertisers alike in being able to engage customers and/or audiences and extend the reach and effectiveness of marketing messages. It is also referred to as Digital Signage.

Digital Signage is a rapidly growing category because busy people are typically busy at home and with the introduction and acceptance of digital video recorders (DVRs), it has diluted the frequency with which traditional television commercials are viewed. Every day more TV viewers are skipping past commercials with their DVRs, making out-of-home advertising all the more appealing. A Nielsen media research study in 2009 showed that 91 percent of DVR owners skipped commercials. As a result, traditional TV advertisers are hungry for an effective substitute, and digital out-of-home ads appear to be one of the solutions. Digital out of home advertising seems to be a cost-effective way for promoting or marketing any brand or product. Usage of billboards and displays for brand promotion is a less expensive way of advertising than television, radio, newspapers and other mediums.

DOOH also includes stand-alone screens, kiosks, and interactive media found in public places. The availability of inexpensive LCD screens with built-in media players has opened the door for companies to add interactive video messages in point of purchase (POP) displays. The displays allow consumers to get additional information at the moment of decision on a product or service. Growth in the DOOH industry has been increasing in 2009, with more POP manufacturers, advertisers, and content developers moving to digital. Technological improvements are holding down costs, and low-cost digital signage is making it easier to reach consumers on a larger scale.

For example, beacons are small devices placed on out-of-home advertising structures that use Bluetooth technology to connect with mobile devices. “Beacons allow you to communicate with the viewer. They also tell you frequency. With these technologies you could say, for example, with certainty that from 3-5 p.m. on a Monday this is how many men or women walked in front of your sign and also what percentage are new people, which are repeat people, etc.

The inventors have recognized the need for more adaptable, mobile digital out-of-home media and advertising. This would be particularly valuable for niche marketing, public events and tailoring global messaging. The inventors of the present disclosure also recognized novelty and consumer interactively greatly augments the marketing efficacy. Present digital signal only provide some of these desirable aspects.

This overview is intended to provide an overview of subject matter of the present patent application. It is not intended to provide an exclusive or exhaustive explanation of the invention. Further limitations and disadvantages of conventional and traditional approaches will become apparent to one of skill in the art, through comparison of such systems with some aspects of the present invention as set forth in the remainder of the present application with reference to the drawings.

### SUMMARY

The present invention relates generally to an aerial display assembly capable of flying under its own power. In particular, the present invention utilizes a frame having a plurality of displays disposed thereon propelled by a plurality of rotors. The flight an aerial display assembly may operate with various degrees of autonomy: either under remote control by a human operator, or fully or intermittently autonomously, by onboard computers.

According to one aspect, the present disclosure comprises a flight capable apparatus for providing media comprising a frame, a plurality of propulsion units, a flight controller, an energy storage device and, one or more displays wherein, said display displays predetermined content during flight.

According to another aspect, the apparatus, further comprising content controller whereby the content controller is in electrical communication with the display and a content controller interface which receives wireless communication instructions and delivers same to content controller.

According to one or more aspects, the apparatus can further include a flight controller interface which receives wireless communication instructions and delivers same to flight controller. In conjunction with the flight controller interface computers can perform fully autonomous flight allowing a single apparatus to be controlled or a plurality of apparatuses to be controlled in coordination with each other. On aspect of this autonomous flight would allow several aerial display assemblies to be flow together to form a single large screen with the messaging divided amount the screens. According to another aspect, the apparatus can have one or more sensors including, but not limited to, infrared, LIDAR, microwave, altitude, and laser distance.

The drawings show exemplary unmanned aerial display vehicles. Variations of these circuits, for example, changing the positions of, adding, or removing certain elements from the circuits are not beyond the scope of the present invention. The illustrated unmanned aerial vehicles are intended to be complementary to the support found in the detailed description.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 shows a front three-quarter view of exemplary unmanned aerial display, in accordance with some embodiments of the disclosure provided herein;

FIG. 2 shows a rear isometric view of exemplary unmanned aerial display, in accordance with some embodiments of the disclosure provided herein;

FIG. 3 depicts a digital systematic abstraction of an exemplary unmanned aerial display, in accordance with some embodiments of the disclosure provided herein;

FIG. 4 illustrates a lateral layout of an exemplary unmanned aerial display, in accordance with some embodiments of the disclosure provided herein; and,

FIG. 5 illustrates a further lateral layout of an exemplary unmanned aerial display, in accordance with some embodiments of the disclosure provided herein.

### DETAILED DESCRIPTION

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

The present invention is directed to systems and devices relating to unmanned aerial vehicles for the purpose of providing digital messaging. More specifically, the present invention discloses a self-powered aerial device with digital signage disposed thereon. The present invention also discloses different mean of control and consumer interactivity.

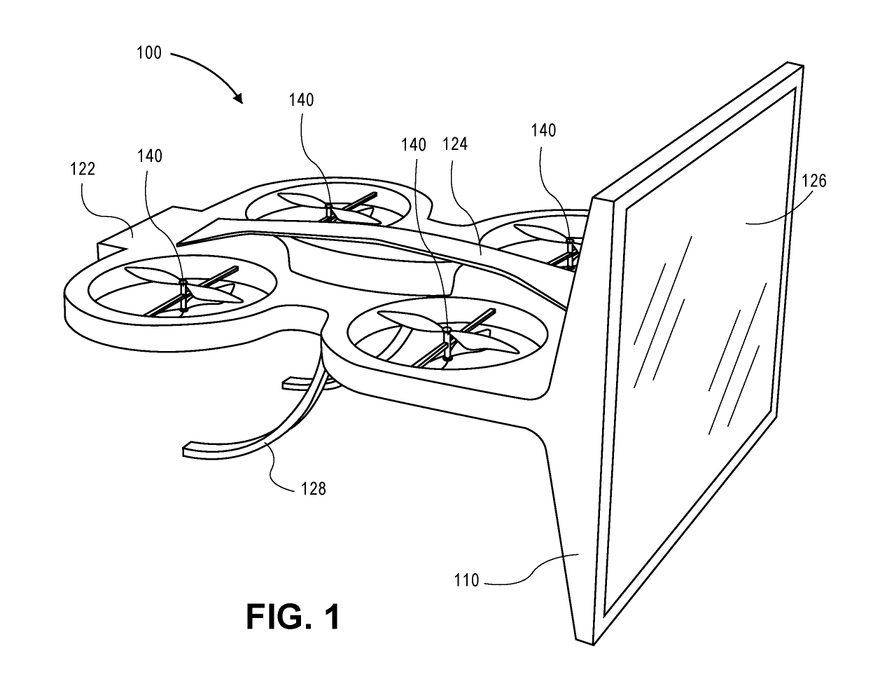

FIG. 1 shows a front three-quarter view of exemplary unmanned aerial display 100, in accordance with some embodiments of the disclosure provided herein. Unmanned aerial display 100 comprises control unit 122, body 124, frame 110, stand 128, display screen 126, and propulsion units 140. power supply 122 is affixed via attachment point to frame 110 and will be discussed in greater detail later in the disclosure.

Frame 110 comprises lightweight material suitable for flight. In some embodiments, frame 110 is made from carbon fiber, polymer or metal. However, any rigid material is not beyond the scope of the present invention. Weight, balance, and aerodynamics may be taken into consideration when mounting one or more displays. Specifically, frame may be counter weighted on the distal end when mounting a single display. In other embodiments, a second display may be mounted at opposite ends or propulsion units can be directed to compensate for any mass imbalance.

In one or more embodiments, propeller ducts 12x is integrated onto frame 110 and made from carbon fiber, polymer or metal. However, any rigid material is not beyond the scope of the present invention.

In one or more embodiments, body 124 is integrated onto frame 110 and made from body shapeable materials such as plastic and foam rubber. Stand 128 comprises similar material and can also be integrated into frame 110. In other embodiments, stand 128 attaches manually to frame 110. Stand 128 may be a single leg or a plurality of members extending towards the lower edge of bezel surrounding display screen 126. Stand 128 functions as support when unmanned aerial display when in not in flight. In an alternated embodiment, stand 128 is shaped aerodynamically to compensate for instabilities due to the shape of one or more display screens 126 and/or bezels.

Frame 110 can have one or more attachment locations for display screen 126. Mounting of the display screen 126 to the frame allows for a solid platform which can be preprogrammed for flight performance. The attachment allows for adjustment of the viewing angle of the display. The adjustment of the viewing angle may be performed manually prior to flight or electronically by during flight based on signals from the onboard sensors. It is preferable to choose a small lightweight digital display screen 126 to minimize the payload carried by the unmanned aerial display 100. As such, the display screen 126 may take the form of a E Ink paper-like display technology, characterized by high brightness and contrast, a wide viewing angle, and ultra-low power requirements or lightweight digital screen utilizing existing technologies, an array of individual LEDs, paper based posters, or any other signage technology which are known in the art. However, future signage is not beyond the scope of the present invention.

In one aspect of the invention, a plurality of display screens 126 allow text, photographs, graphic images, audio streams, and video to be displayed as a single message (single display) over a plurality of display screens 126. According to another aspect, several texts, photographs, graphic images, audio feeds, and video shown on individually on each of the plurality display screens 126. fully autonomous flight allows a plurality of apparatus to be controlled in coordination with each other. On aspect of this autonomous flight would allow several aerial display assemblies to be flown together to form a single large screen with the messaging divided amount the screens much like a jumbotron. The size, numbers, and type of display screens 126 may be chosen based on communication bandwidth required fora particular implementation of the present invention and may change between different embodiments. Smaller digital display screens 126 are used when viewers are close to the unmanned aerial display 100. LED arrays are more suited when the viewer is at a longer distance.

In one or more embodiments of the disclosure, propulsion units 140 are propellers driven by motors or engines and propeller ducts. Electrical energy is delivered and controlled thereto by control unit 122. However, fans and even miniaturized jets are not beyond the scope of the present invention.

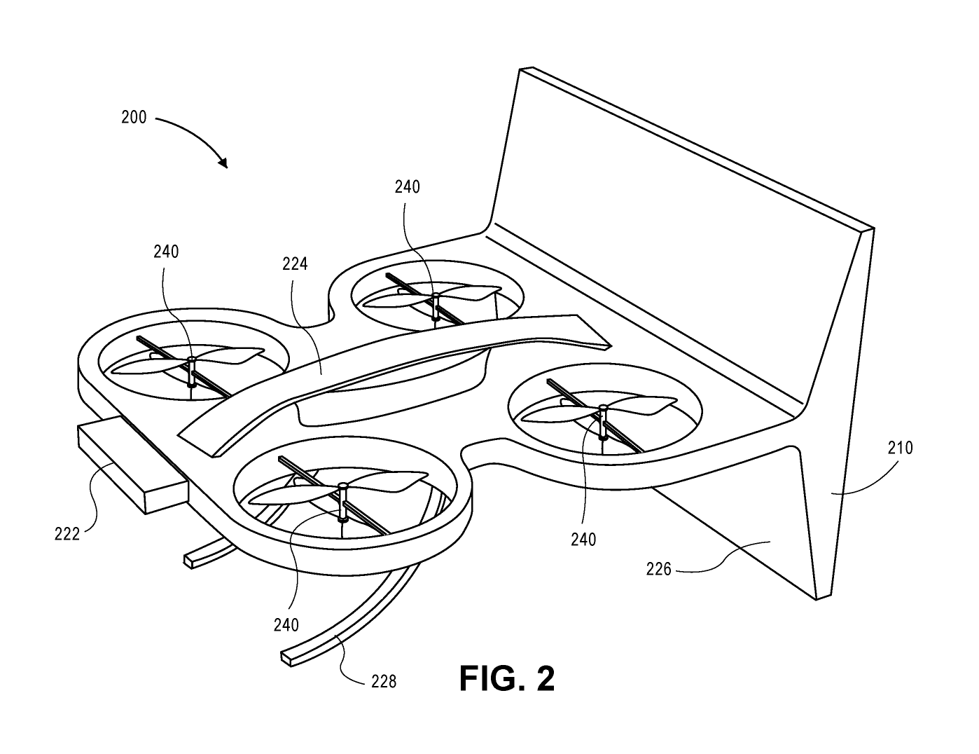

FIG. 2 shows a rear isometric view of exemplary unmanned aerial display 200, in accordance with some embodiments of the disclosure provided herein. Unmanned aerial display 200 comprises control unit 222, body 224, frame 210, stand 228, display screen 226, and propulsion units 240. Control unit 222 is affixed via attachment point to frame 210 and will be discussed in greater detail later in the disclosure.

FIG. 2 is depicted for clarity and comprehension. The descriptions associated with FIG. 1 are applicable to FIG. 2. That is, unmanned aerial display 200, control unit 222, body 224, frame 210, stand 228, display screen 226, and propulsion units 240 are equivalents to unmanned aerial display 100 comprises control unit 122, body 124, frame 110, stand 128, display screen 126, and propulsion units 140.

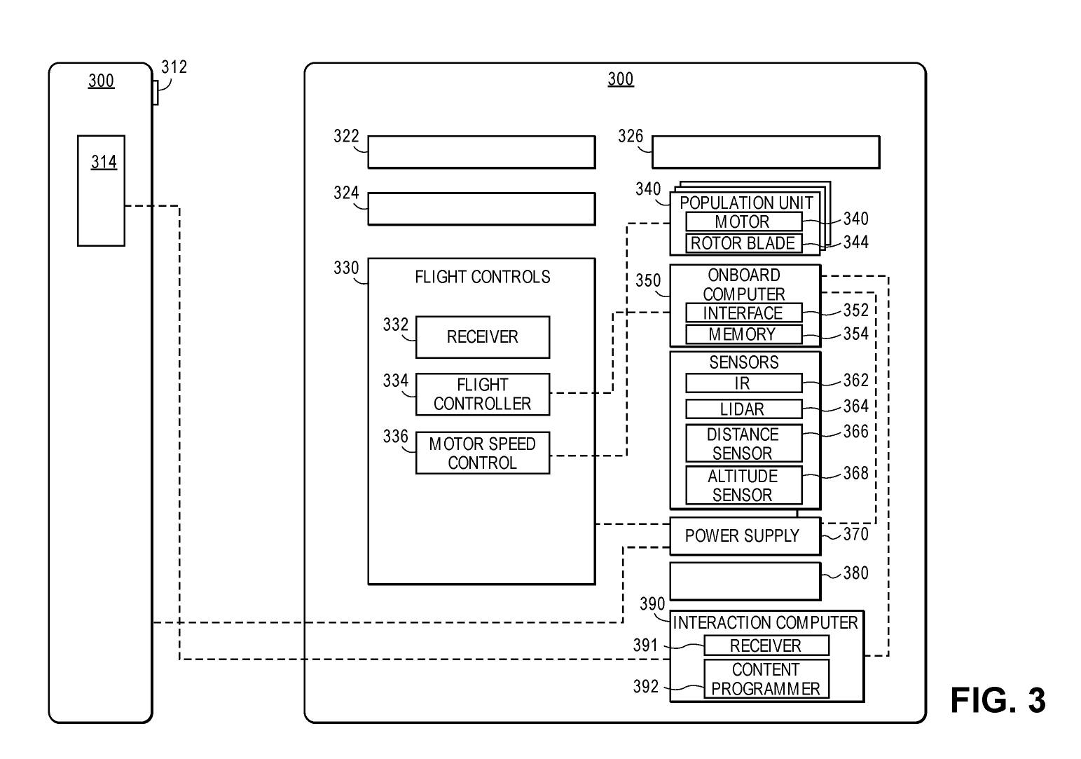

FIG. 3 depicts a digital systematic abstraction of an exemplary unmanned aerial display, in accordance with some embodiments of the disclosure provided herein. Systematically, unmanned aerial display 300 comprises display attachment 322, propulsion unit attachment 324, flight controls 330, component attachment 326, propulsion unit 340, onboard computer 350, sensor array 360, power supply 370, power supply attachment 380, interaction computer 390.

Flight controls 330 comprise receiver 332, flight controller 334, motor speed controller 336. The component assembly flight controls 330 may comprise conventional components and arrangements well known and widely utilized in the relevant arts. A receiver 332 is programmed to receive flight instructions from an operator with a transmitter or from a pre-programmed computer broadcasting signal over a predetermined frequency. The flight controller 334 interprets the received signals and provides instructions to motor speed controls 336 to allow for movement for the unmanned aerial display 100 in accordance with the operator or computer program instruction.

Propulsion unit attachments 324 provide support for propulsion components 340 comprising motors 342 and propellers 344. Using a computer for the control of flight eliminates the potential for human error and allows the use of sensors which can allow flight controls 330 to deploy safety programs that initiate launch, land, obstacle avoidance sequences and additional safety measures without operator interaction.

In regards to a particular embodiment of the present invention, one or more on board computer components 350 may be included. The computer component 350 may comprise conventional commercially available examples such as Raspberry Pi, and or Arduino, and/or many similar programmable computers well known in the arts. Computer components 350 typically include an interface 352 to receive wireless or hardwired instructions. The interface 352 also communicates with sensor array 360. The computer component 350 is able to provide flight instructions to flight controls 130. The flight instruction may work in tandem with or in exception to flight instruction received through the receiver 332.

In one or more embodiments, sensor array 360 may contain an array of sensors to collect information during flight and store in memory 354. Sensor information is provided to the computer component 350 and is processed into instructions for flight controller 334. Sensor array 360 comprises infrared sensors 362, LIDAR sensors 364, distance detectors 366, altitude sensors 368.

Infrared sensors 362 are used for data collection in low light. Lidar sensors 364 are used to provide detailed mapping information. Distance detectors 366 provide information on the travel distance to objects which can be processed by the computer component 350 and modify flight instructions to the flight controller 334. Altitude sensors 368 provides the altitude at which the unmanned aerial display 100 is flying. Altitude sensors 368 can provide real time information to the computer component 350 to modify control signals to the flight controller 334 to maintain an altitude or measure changes.

The present disclosure allows safe flight near observers facilitates and interactions therewith. Observers will be able to message the unmanned aerial display 100 and receive replies or other interactions. In some embodiments, unmanned aerial display 100 may be programmed to respond to commands sent by an observer.

With respect to a particular embodiment of the present invention, one or more on-board interaction computer 390 components may be included. Interaction computer 390 may comprise conventional commercially available examples such as Raspberry Pi, and or Arduino, and/or many similar programmable computers well known in the arts. Interaction computer 390 components typically comprise an interface 391 to receive wireless or hardwired instructions and content programmer 392.

In some embodiments, content programmer 392 also communicates with Onboard Computer 350. The interaction computer 390 is able to interact with the public and provide flight instructions to Onboard Flight Computer 350. The flight instruction may work in tandem with or in exception to flight instruction received through the receiver 332. Interaction computer 390 is able to interact with the public and provide changes in display content to display 226 via display interface 314. Mounting point 312 is used to securely fasten display 226 to unmanned aerial unit 100, 200.

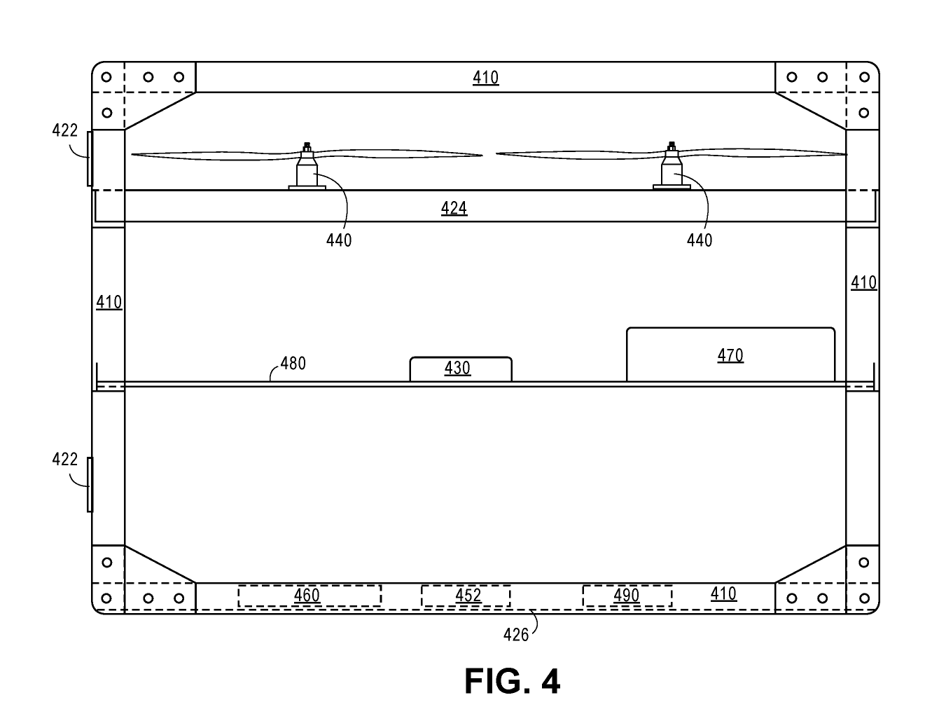

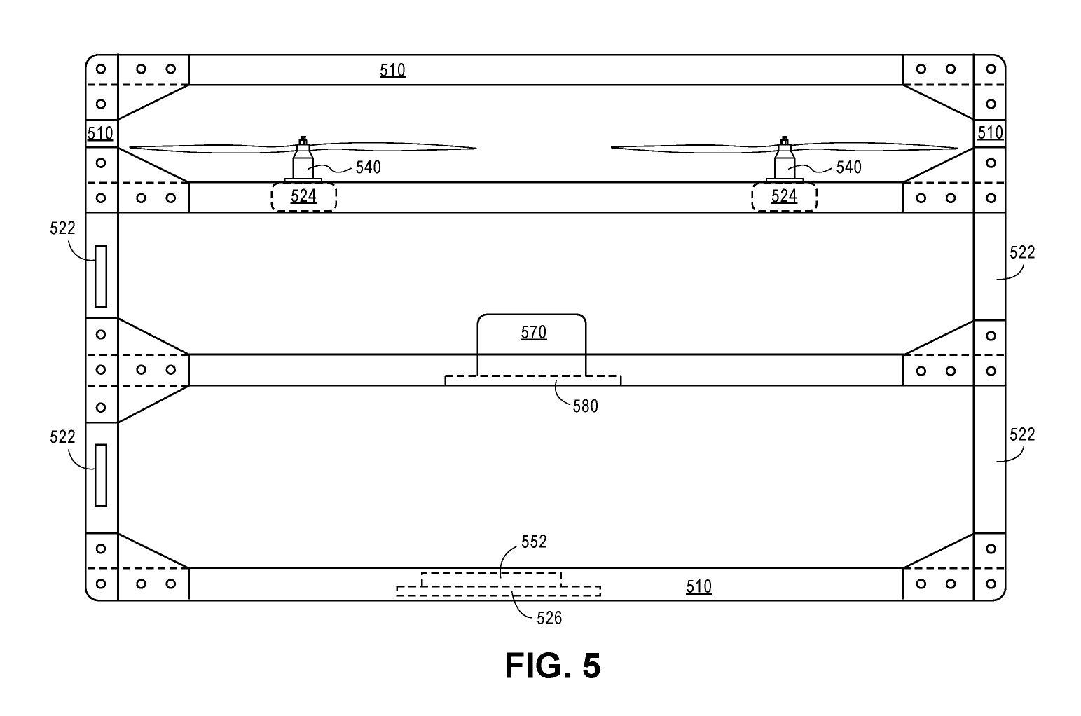

FIGS. 4-5 illustrate lateral layouts of an exemplary unmanned aerial display, in accordance with some embodiments of the disclosure provided herein. Sensor array 460 onboard can allow for deployment of new technologies such as face recognition, hash tag messaging, and virtual reality display. A power supply component 470, 570 preferably comprising one or more rechargeable batteries or like charge retaining components are provided. The power supply 470, 570 can provide the required voltage and current to the display(s) 200, flight controls 430, computer component 350, and sensor array 460.

The propulsion component 440, 540 may receive power from the power supply 470, 570 and also from the motor speed control 336. A power conduit in the form of a polymeric tube having electrically conductive elements therein may be mated to an external power source to replenish power contained in the power supply via power supply attachment 480, 580.

One or more displays 200 are shown to include a vehicle attachment device 312 that mates with mounting points such that the displays 200 are secured to the unmanned aerial display system. In some embodiments, options such as speed and elevation may be programmed to optimize the visual range. Unmanned aerial display 100 has a supporting frame work 410, 510 which includes mounting points 422, 522 configured to accept a number of differently configured displays 200.

The frame work 410, 510 also includes a component attachment platform 426, 526 preferably comprising ridged sheet or a hollow tubular frame. Power unit attachment platform 480, 580 is a flat plate disposed approximately midway along the height of the frame work 410, 510 having the power supply component 470, 570 and the flight controls 430 disposed thereon.

Various different types of fasteners may be utilized to fasten the power unit attachment platform 480, 580 and the component attachment platform 426, 526 to the frame work 410, 510 such as screws, nuts, magnetic fasteners, snap fasteners, and like fastening mechanisms utilized in the relevant arts. The specific design and mounting of the component attachment platform 426, 526 and the power unit attachment platform 480, 580 may change in order to provide the required structural strength, balance, optimization of airflow, location of center of gravity, and clearance of obstructions for propellers which spin at high velocities by the motors 424, 524 of the propulsion units 440, 540.

In some embodiments, observer interaction can include the display of Q-code which observers can scan using mobile devices. In other embodiments, observers can communicate with the unmanned aerial vehicle with SMS texting. In still other embodiments, touch screens are used to navigate through display media and/or control the unmanned vehicle to perform predetermined functions or performances.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A flight capable apparatus for providing media comprising:
a frame;
a plurality of propulsion units;
a computer;
a flight controller;
an energy storage device; and,
a display;
wherein, said display displays messaging content during flight.

2. The apparatus of claim 1, further comprising content controller whereby the content controller is in electrical communication with the display.

3. The apparatus of claim 2, further comprising a content controller interface which receives wireless communication instructions and delivers same to the content controller.

4. The apparatus of claim 1, further comprising a flight controller interface which receives wireless communication instructions and delivers same to the flight controller.

5. The apparatus of claim 1, wherein the plurality of propulsion units comprise propellers.

6. The apparatus of claim 5, wherein the plurality of propulsion units further comprise motors which drive the propeller.

7. The apparatus of claim 1, wherein the energy storage device is a battery.

8. The apparatus of claim 1, further comprising an attachment adjustable for viewing angle of the display.

9. The apparatus of claim 1, further comprising an attachment for attaching a second display.

10. The apparatus of claim 9, further comprising a second display.

11. The apparatus of claim 1, wherein the display is an Eink.

12. The apparatus of claim 1, wherein the display is a TFT screen.

13. The apparatus of claim 1, wherein the plurality of propulsion units are powered by the energy storage device through the flight controller.

14. The apparatus of claim 1, wherein the frame substantially comprises a polymer.

15. The apparatus of claim 1, wherein the frame comprises carbon fiber.

16. The apparatus of claim 1, further comprising a sensor.

17. The apparatus of claim 16, wherein the sensor is in electrical communication with the flight controller.

18. The apparatus of claim 17, wherein the sensor is a LIDAR sensor.

19. The apparatus of claim 17, wherein the sensor is an altitude sensor.

20. The apparatus of claim 17, wherein the sensor is a distance sensor.
